(19) United States
(12) Patent Application Publication
(10) Pub. No.: US 2026/0019853 A1
(43) Pub. Date: Jan. 15, 2026

(54) SYSTEM AND METHOD FOR EVALUATING DEVICE PERFORMANCE IN A NETWORK

(71) Applicant: JIO PLATFORMS LIMITED, Ahmedabad, Gujarat (IN)

(72) Inventors: Aayush BHATNAGAR, Navi Mumbai, Maharashtra (IN); Haresh B AMBALIYA, Bhundani, Gujarat (IN); Makarand DERE, Panvel, Maharashtra (IN); Vikram SINGH, Mumbai, Maharashtra (IN); Pradeep Kumar BHATNAGAR, Navi Mumbai, Maharashtra (IN)

(73) Assignee: JIO PLATFORMS LIMITED, Ahmedabad, Gujarat (IN)

(21) Appl. No.: 18/993,040

(22) PCT Filed: May 2, 2024
(86) PCT No.: PCT/IN2024/050471

§ 371 Date: Jan. 10, 2025

(30) Foreign Application Priority Data
May 30, 2023 (IN) 202321037380

(51) Int. Cl. H04W 24/10; H04W 4/029; H04W 24/08

(52) U.S. Cl. CPC H04W 24/10; H04W 4/029; H04W 24/08

(57) ABSTRACT

The present disclosure method (600) for evaluating performance of one or more user devices (106) in a network (108). The method comprising identifying (602) a geographical region, identifying (604) one or more user devices (106) communicatively coupled to the network (108) in the geographical region and receiving (606) a sample data related to parameters associated with the one or more user devices (106). The method comprising receiving (608) a threshold value related to each parameter of the parameters for the evaluation, obtaining (610) a weightage value associated with each parameter. The method comprising calculating (612) a score for each of the one or more user devices (106) using the one or more parameters based on a processing of the sample data, the threshold value, and the weightage value corresponding to each parameter and evaluating (614) the performance of the one or more user devices (106) based on the calculated score.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF DISCLOSURE

The embodiments of the present disclosure generally relate to performance evaluation of a device in a communication network. In particular, the present disclosure relates to monitoring the performance of different devices in a communication network based on measurements obtained from different devices.

### BACKGROUND OF DISCLOSURE

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In the telecom age, the performance of a network plays a vital role in analyzing the capabilities of the underlying network infrastructure. The network performance depends on several factors, for example, the number of user devices serviced by the network. With the exponentially growing number of user devices, there is a strain associated with the network to service them, resulting in a degradation in the performance of both the network and the devices.

In order to address the performance of devices and the network, network service providers, device manufacturers, and software providers play an important role by enabling the collection of different parameters associated with the device and network and evaluating a performance of the devices in the network.

However, there is still a scope of development of monitoring the performance of the devices in the network for optimization of resources.

There is, therefore, a need in the art to provide a method and a system that can overcome the shortcomings of the existing prior arts.

### DEFINITION

As used in the present disclosure, the following terms are generally intended to have the meaning as set forth below, except to the extent that the context in which they are used to indicate otherwise.

The term RSRP as used herein, refers to reference signal received power (RSRP). The RSRP is a measure of the received power level in an LTE cell network. The average power is a measure of the power received from a single reference signal.

The term SINR as used herein, refers to signal to interference and noise ratio. The SINR measures signal quality: the strength of the wanted signal compared to the unwanted interference and noise.

The term CQI as used herein, refers to a channel quality indicator (CQI). In the LTE system, the CQI is used by the user equipment (UE) to indicate the channel quality to the eNodeB. The CQI reported value indicates the level of modulation and coding the UE could operate.

The term RSRQ as used herein, refers to a reference signal received quality. The RSRQ is a key parameter in wireless communication systems, particularly in the context of cellular networks like 4G LTE and 5G. RSRQ quantifies the quality of the received reference signal from the serving cell's base station (cell tower).

### OBJECTS OF THE PRESENT DISCLOSURE

Some of the objects of the present disclosure, which at least one embodiment herein satisfies are as listed herein below.

It is an object of the present disclosure to monitor device performance in a network.

It is another object of the present disclosure to provide identification of plurality of devices based on the performance in the network.

It is yet another object of the present disclosure to enable service providers to evaluate the active devices in a dynamic manner.

It is yet another object of the present disclosure to optimize network resources.

It is yet another object of the present disclosure to plan the network.

It is yet another object of the present disclosure to optimize the cost associated with the network deployment and infrastructure.

It is yet another object of the present disclosure to categorize one or more devices based on performances.

### SUMMARY

In an exemplary embodiment, the present invention discloses a method for evaluating performance of one or more user devices in a network. The method comprising identifying a geographical region. The method comprising identifying one or more user devices communicatively coupled to the network in the geographical region. The method comprising receiving a sample data related to one or more parameters associated with the one or more user devices. The method comprising receiving a threshold value related to each parameter of the one or more parameters for the evaluation. The method comprising obtaining a weightage value associated with each parameter. The method comprising calculating a score for each of the one or more user devices using the one or more parameters based on a processing of the sample data, the threshold value, and the weightage value corresponding to each parameter. The method comprising evaluating the performance of the one or more user devices based on the calculated score.

In some embodiments, the method further comprising dividing the identified geographical area into a grid based on a defined grid size. A grid refers to a network of intersecting lines or pathways that form a geometric shape such as rectangle, square, rhombus, etc. A cell site may be divided into a number of grids. In an example embodiment, the grids may include a 5×5 meter grid size. The grid size may be selected as per required output quality, for example, smaller the grid better the bench marking quality.

In some embodiments, the method further comprising selecting a block in the grid having the user devices that are of different makes and models. A block may refer to a unit space caused by the intersection of the intersecting lines of the grid. A grid may include a plurality of blocks. The user devices may be from two different mobile device manufacturers or may be different models from the same manufacturer.

In some embodiments, the user devices are communicatively coupled to the network from a single cell corresponding to the grid of the same geographical area.

In some embodiments, the sample data is associated with the user devices (106) having a same cell identifier (ID) and a same input source.

In some embodiments, the sample data comprises data related to the one or more parameters measured and reported by the user devices for a pre-defined period of time.

In some embodiments, the method further comprising selecting any one parameter for evaluation and calculating an average value of the received sample data for each make and model.

In some embodiments, the method further comprising providing a ranking to each make and model in the identified geographical area based on the calculated score.

In some embodiments, the one or more parameters include at least one of a reference signal received power (RSRP), a signal-to-interference-plus-noise ratio (SINR), a channel quality information (CQI), a reference signal received quality (RSRQ), call drop, call mute and an uplink (UL) interference.

In an exemplary embodiment, the present invention discloses a system for evaluating performance of one or more user devices in a network. The system comprising a receiving unit configured to receive a sample data related to one or more parameters associated with the one or more user devices and receive a threshold value related to each parameter of the one or more parameters for the evaluation. A database configured to store the sample data related to the one or more parameters associated with the one or more user devices and store the threshold value related to each parameter for the evaluation. A processing unit coupled to the receiving unit and the database and is configured to identify a geographical region and identify the one or more user devices communicatively coupled to the network in the geographical region. The processing unit configured to obtain a weightage value associated with each parameter, calculate a score for each of the one or more user devices using the one or more parameters based on a processing of the sample data, the threshold value, and the weightage value corresponding to each parameter and evaluate the performance of the one or more user devices based on the calculated score.

In some embodiments, the system is further configured to divide the identified geographical area into a grid based on a defined grid size.

In some embodiments, the system is further configured to select a block in the grid having the user devices that are of different makes and models.

In some embodiments, the user devices are communicatively coupled to the network (108) from a single cell corresponding to the grid of the same geographical area.

In some embodiments, the sample data is associated with the user devices (106) having a same cell identifier (ID) and a same input source.

In some embodiments, the system the sample data comprises data related to the one or more parameters measured and reported by the user devices for a pre-defined period of time.

In some embodiments, the system is further configured to select any one parameter for evaluation and calculate an average value of the received sample data for each make and model.

In some embodiments, the system is further configured to provide a ranking to each make and model in the identified geographical area based on the calculated score.

In some embodiments, the one or more parameters include at least one of a reference signal received power (RSRP), a signal-to-interference-plus-noise ratio (SINR), a channel quality information (CQI) and a reference signal received quality (RSRQ), call drop, call mute and an uplink (UL) interference.

In an exemplary embodiment, the present invention discloses a user equipment (UE) communicatively coupled with a network in a geographical region. The coupling comprises steps of receiving, by the network, a connection request sending an acknowledgment of the connection request to the UE and transmitting a plurality of signals in response to the connection request. The network comprising a plurality of network elements configured to receive a sample data related to one or more parameters associated with the UE, receive a threshold value related to each parameter of the one or more parameters, obtain a weightage value associated with each parameter, calculate a score for each of the UE using the one or more parameters based on a processing of the sample data, the threshold value, and the weightage value corresponding to each parameter and evaluate performance of the UE based on the calculated score.

Thus, the present invention discloses first identifying the best category of user device amongst all category of user devices in a grid served by a same cell for a particular KPI. Score the best category as 1 for that KPI in that grid. Compare the other category of user devices with it and if any user device is beyond the pre-defined threshold of that KPI then tag the score to that category of user device for that grid as 0. The other category of user devices falling between the pre-defined threshold and the best in that grid are mapped with score in steps between 1 to 0 as per the descending value of the KPI. Similarly, all KPIs in the grid are checked. Thus, the score for each KPI for each category of the user devices reported in that grid and served by same cell are determined. Thus, the individual score of all categories of the user devices that are reported in that grid are derived. Thus, a score for all category of user devices in the network for every grid where they reported is derived. Further, the score of each category of user device for whole geographical region is derived and all these category of user devices are compared based on its final score. The best to worst user device can be tagged based on the score which is nothing but the radio frequency (RF) performance.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components or circuitry commonly used to implement such components.

FIG. 1 illustrates an exemplary network architecture in which or with which a proposed system may be implemented, in accordance with embodiments of the present disclosure.

FIG. 2 illustrates an exemplary block diagram representation of a system for evaluating performances of devices in the network, in accordance with embodiments of the present disclosure.

FIG. 3 illustrates an exemplary flow chart for a method for evaluating performances of devices in the network, in accordance with embodiments of the present disclosure.

FIG. 4 illustrates an exemplary computer system in which or with which embodiments of the present disclosure may be implemented.

FIG. 5 illustrates an exemplary flow chart for a method for evaluating performances of devices in the network, in accordance with embodiments of the present disclosure.

FIG. 6 illustrates another exemplary flow chart for a method for evaluating performances of devices in the network, in accordance with embodiments of the present disclosure.

The foregoing shall be more apparent from the following more detailed description of the disclosure.

### LIST OF REFERENCE NUMERALS

100—Network architecture
102—Cell site
104—A plurality of grids
106—A plurality of user devices
110—System
112, 214—Comparison unit
114, 216—Evaluation unit
200—Block Diagram
202—A plurality of processor(s)
204—Memory
206—A plurality of interface(s)
208—Processing unit
210—Database
212—Receiving unit
214—Comparison Unit
218—Other unit(s)
300—Flow Chart
400—A computer system
410—External storage device
420—Bus
430—Main memory
440—Read only memory
450—Mass storage device
460—Communication port(s)
470—Processor
500—Flow Chart
600—Flow Chart

### DETAILED DESCRIPTION OF DISCLOSURE

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In some aspects, the present disclosure relates to a system and a method for evaluating devices in network. In an embodiment, the method facilitates monitoring of device performance in the network and facilitates identification of a plurality of devices based on the performance in the network. Further, the method enables service providers to evaluate the active devices in a dynamic manner and enable the operators to manage the network in a better and an efficient way by optimizing the resources.

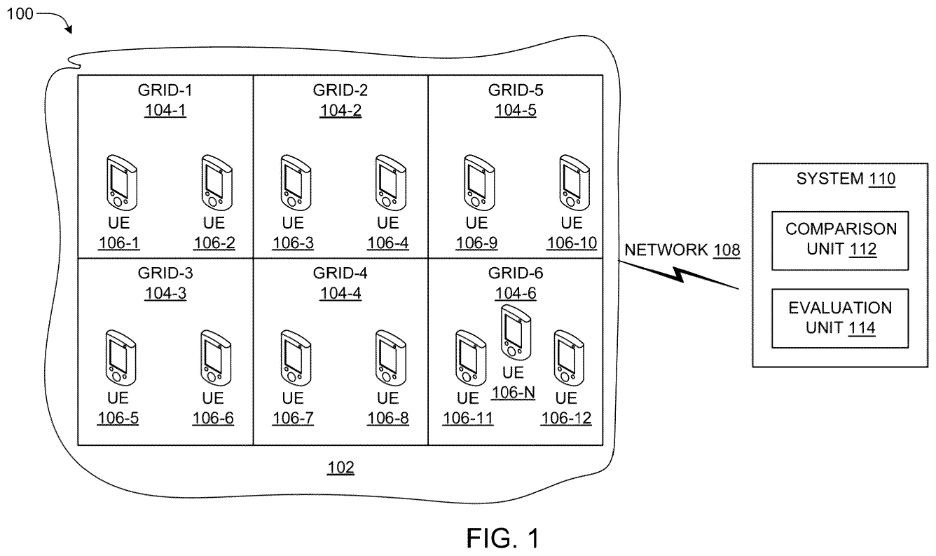

The various embodiments throughout the disclosure will be explained in more detail with reference to FIGS. 1-6.

FIG. 1 illustrates an exemplary network architecture (100) in which or with which embodiments of the present disclosure may be implemented.

The network architecture (100) may include a cell site (102) divided into one or more grids or sub-regions (104-1, 104-2 . . . 104-N) where one or more user devices (106-1, 106-2 . . . 106-N) associated with one or more users are deployed. A person of ordinary skill in the art will understand that one or more grids may be individually referred to as the grid (104) and collectively referred to as the grids (104). Further, a person of ordinary skill in the art will understand that one or more user devices may be individually referred to as the user device (106) and collectively referred to as the user devices (106).

In an embodiment, each user device (106) may interoperate with every other user device (106) in the network architecture (100). In an embodiment, the user devices (106) may be referred to as a user equipment (UE). In some embodiments the user devices (106) may be referred to as a computing device. A person of ordinary skill in the art will appreciate that the terms “user device(s),” “computing device(s),” and “UE” may be used interchangeably throughout the disclosure.

In an embodiment, the user devices (106) may include, but are not limited to, a handheld wireless communication device (e.g., a mobile phone, a smart phone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of user device (106) with wireless communication capabilities, and the like. In an embodiment, the user devices (106) may include, but are not limited to, any electrical, electronic, electro-mechanical, or an equipment, or a combination of one or more of the above devices such as virtual reality (VR) devices, augmented reality (AR) devices, laptop, a general-purpose computer, desktop, personal digital assistant, tablet computer, mainframe computer, or any other computing device, wherein the user device (106) may include one or more in-built or externally coupled accessories including, but not limited to, a visual aid device such as camera, audio aid, a microphone, a keyboard, and input devices for receiving input from a user such as touch pad, touch enabled screen, electronic pen, and the like.

A person of ordinary skill in the art will appreciate that the user devices or UEs (106) may not be restricted to the mentioned devices and various other devices may be used.

The user devices (106) may communicate with a system (110), for example, a performance evaluation system, through a network (108). In an embodiment, the network (108) may include at least one of a Second Generation (2G), Third Generation (3G), Fourth Generation (4G) network, a Fifth Generation (5G) network, Sixth Generation (6G) and beyond or the like. In some embodiments, the network (108) may include multiple bands and multiple carriers. The network (108) may enable the user devices (106) to communicate between devices (106) and/or with the system (110). As such, the network (108) may enable the user devices (106) to communicate with other user devices (106) via a wired or wireless network. The network (108) may include a wireless card or some other transceiver connection to facilitate this communication. In an exemplary embodiment, the network (108) may incorporate one or more of a plurality of standard or proprietary protocols including, but not limited to, Wi-Fi, Zigbee, or the like. In another embodiment, the network (108) may be implemented as, or include any of a variety of different communication technologies such as a wide area network (WAN), a local area network (LAN), a wireless network, a mobile network, a Virtual Private Network (VPN), the Internet, the Public Switched Telephone Network (PSTN), or the like.

The system (110) may include a comparison unit (112) for comparing performance of different user devices (106) and an evaluation unit (114) for evaluating the performance of the user devices (106).

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

In an exemplary embodiment, a cell site (102) for performing device analytics is selected. Further, the selected cell site (102) is divided into a number of grids (104). In an example embodiment, the grids (104) may include a 5×5 meter grid. The grid size may be selected as per required output quality, for example, smaller the grid better the bench marking quality.

In an exemplary embodiment, the system (110) checks for the availability of samples from at least two different user devices (106) and whether all the user devices are connected to the network (108) from a single cell site (102). If the above criteria are satisfied, the system (110) may check for one or more parameters associated with the user device (106) and may evaluate an average value of samples associated with a particular grid for each type and make of user device (106). In some embodiments, the system (110) may evaluate a mean, minimum, or maximum value, or the like, of the samples associated with a particular grid for each type and make of user device (106). The user devices (106) may be communicatively coupled with the network (108) in the geographical region. The coupling comprises steps of receiving, by the network (108), a connection request sending an acknowledgment of the connection request to the user devices (106) and transmitting a plurality of signals in response to the connection request.

In an exemplary embodiment, the system (110) may identify a first user device (106-1) with parameter value and assign score 1 to the first user device (106-1). Similarly, the system (110) may identify a second user device (106-2) with the lowest parameter value and assign a score of 0 to the second user device (106-2). For the other user devices for which the parameter value falls in between best and lowest, the system (110) may assign a score(s) based on the score step defined for the respective parameters. Further, the system (110) may store parameter values for each model of the user device (106) along with the number of samples for further calculations, and the system (110) may repeat the above steps in a single grid (104-1) till all the parameters are evaluated. In an exemplary embodiment, the system (110) may check for remaining grids (104) that are not evaluated through the above steps and repeat all steps for all possible grids (104) in the cell site (102).

In an exemplary embodiment, the evaluation unit (114) may calculate a score for each key performance indicator (KPI) for each make and model of user devices (106) as sum grid score*100/sum of samples and a final score for each make and model is evaluated as (Sum (KPI1 Score*Weight+KPI_{n*}Weight n)), wherein the weight factors are predefined.

In an exemplary embodiment, the system (110) may select the user device (106) or handset with highest score as best performing handset and the user device (106) with the lowest score as poor performing handset. In an exemplary embodiment, the weight factor of respective parameters as per algorithm settings and the weight factor and score may be configurable.

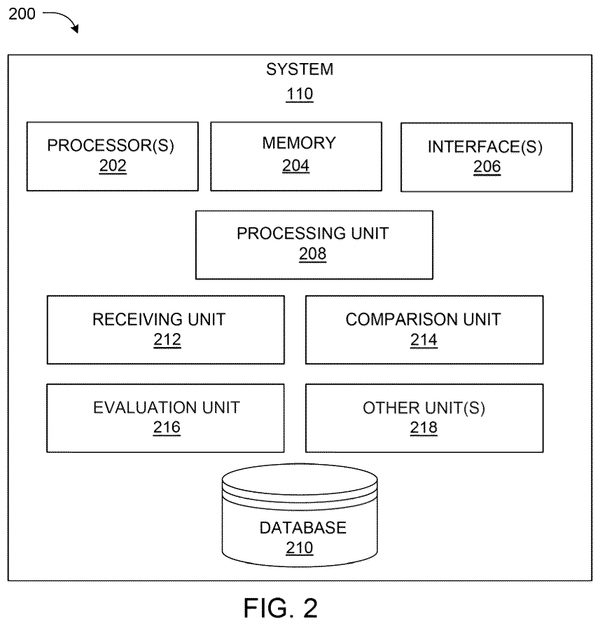

FIG. 2 illustrates an exemplary block diagram representation (200) of a system (110) for evaluating performances of user devices (106) in the network (108), in accordance with embodiments of the present disclosure.

For example, the system (110) may include one or more processor(s) (202). The one or more processor(s) (202) may be implemented as one or more microprocessors, microcomputers, microcontrollers, edge or fog microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (110). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as Random-Access Memory (RAM), or non-volatile memory such as Electrically Erasable Programmable Read-only Memory (EPROM), flash memory, and the like.

In an embodiment, the system (110) may include an interface(s) (206). The interface(s) (206) may comprise a variety of interfaces, for example, interfaces for data input and output devices, referred to as input/output (I/O) devices, storage devices, and the like. The interface(s) (206) may facilitate communication for the system (110). The interface(s) (206) may also provide a communication pathway for one or more components of the system (110). Examples of such components include, but are not limited to, processing unit/engine(s) (208) and a database (210).

The processing unit/engine(s) (208) may be implemented as a combination of hardware and programming (for example, programmable instructions) to implement one or more functionalities of the processing unit (208). In examples described herein, such combinations of hardware and programming may be implemented in several different ways. For example, the programming for the processing unit(s) (208) may be processor-executable instructions stored on a non-transitory machine-readable storage medium and the hardware for the processing unit(s) (208) may comprise a processing resource (for example, one or more processors), to execute such instructions. In the present examples, the machine-readable storage medium may store instructions that, when executed by the processing resource, implement the processing unit(s) (208). In such examples, the system (110) may include the machine-readable storage medium storing the instructions and the processing resource to execute the instructions, or the machine-readable storage medium may be separate but accessible to the system (110) and the processing resource. In other examples, the processing engine(s) (208) may be implemented by electronic circuitry. In an aspect, the database (210) may comprise data that may be either stored or generated as a result of functionalities implemented by any of the components of the processor (202) or the processing unit(s) (208).

In an embodiment, the processing unit(s) (208) may include units that receive readings from the user devices (106) of FIG. 1 via a network (108), compare the received readings, and evaluate a performance associated with various parameters of user device (106) when deployed in a cell site (102). In an embodiment, the collected readings may be stored at the database (210). In an embodiment, the processing unit (208) may include one or more modules/units such as, but not limited to, a receiving unit (212), a comparison unit (214), an evaluation unit (216), and other unit(s) (216). A person of ordinary skill in the art will understand that the comparison unit (214) and the evaluation unit (216) may be similar in its functionality with the comparison unit (112) and the evaluation unit (114) of FIG. 1.

In an embodiment, the database (210) may store the one or more parameters, threshold values, key performance indicators, etc., against which the user device (106) performance may be evaluated. By way of example but not limitation, the one or more processor(s) (202) may obtain readings from the user device (106). In an embodiment, the receiving unit (212) is further configured to receive pre-defined threshold value related to each parameter for the performance evaluation. The database (210) configured to store the received sample data related to the one or more parameters associated with the one or more user devices (106) and store the received threshold value related to each parameter for the performance evaluation. These values may be used by the comparison unit (214) and the evaluation unit (216) for evaluating performance of the user device (106) in the network (108).

A person of ordinary skill in the art will appreciate that the exemplary block diagram (200) may be modular and flexible to accommodate any kind of changes in the system (120).

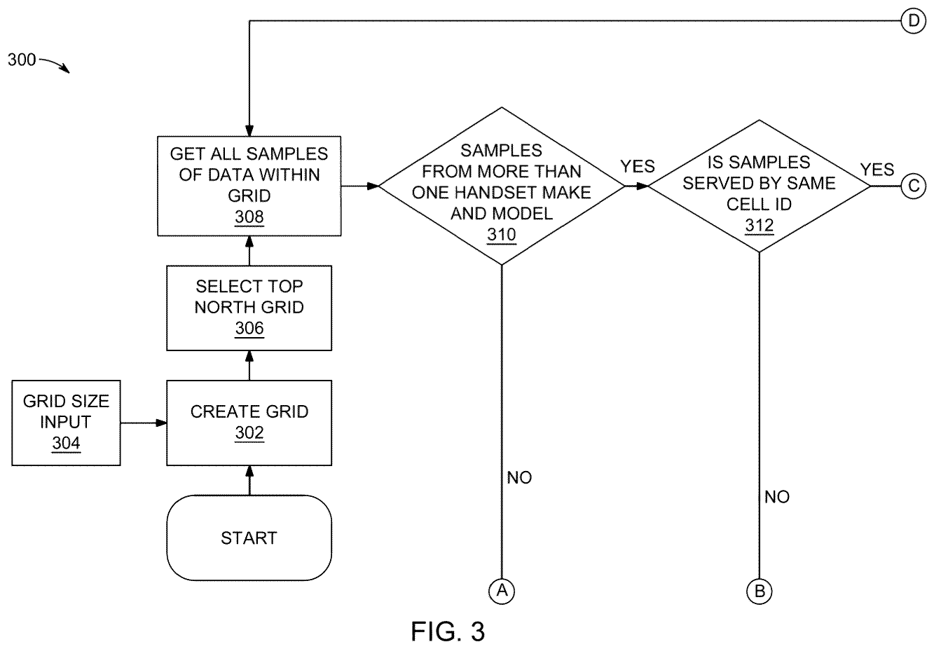

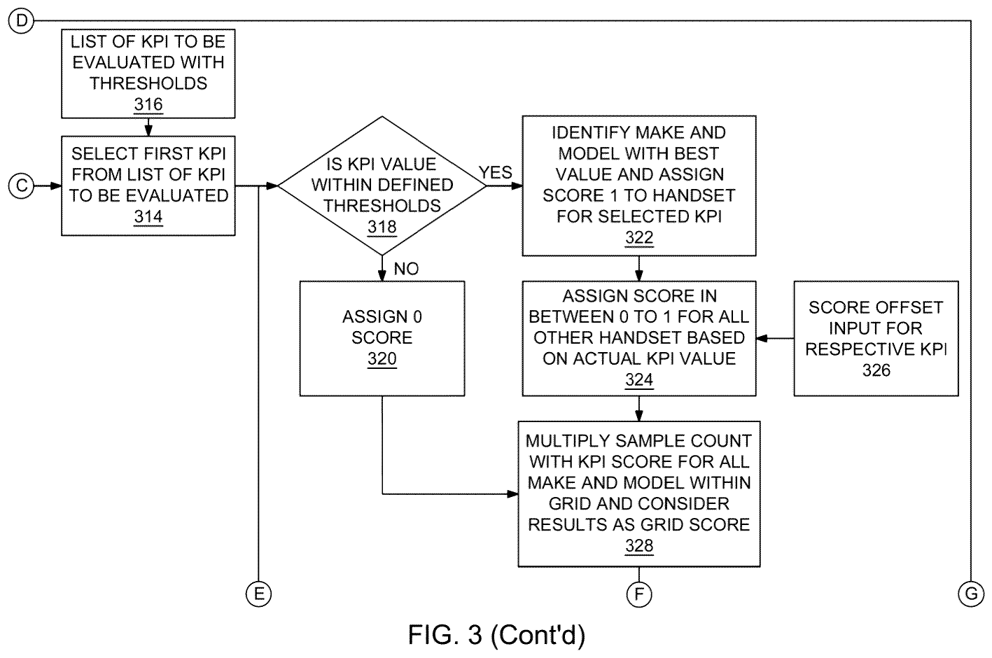

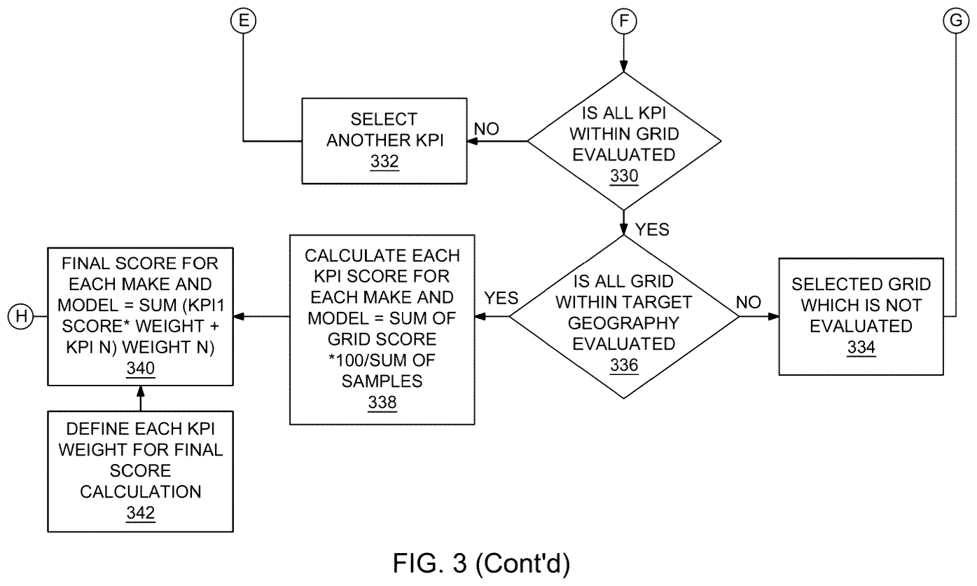

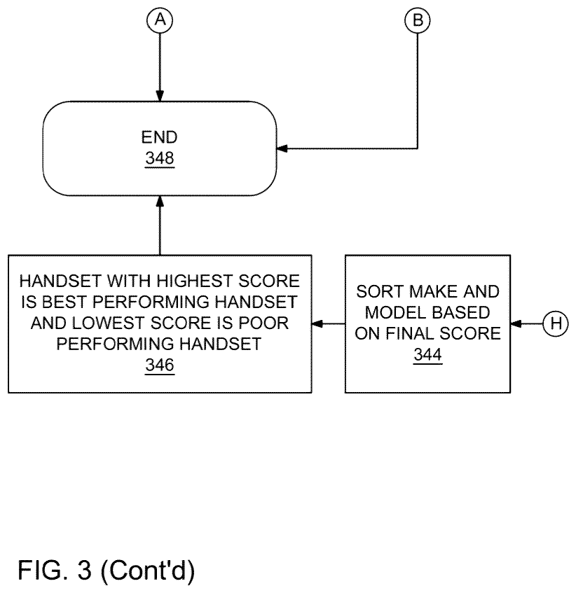

FIG. 3 illustrates an exemplary flow chart for a method (300) for evaluating performances of user devices (106) in the network (108), in accordance with embodiments of the present disclosure.

In some embodiments, a method (300) for evaluation of the user devices (106) in the network (108) of FIG. 1 served by same cell identifier (ID) may be achieved by evaluating unique KPI from a plurality of KPIs, in each of active multi-vendor user devices (106) in a specific grid (104) and determining a score based on one or more pre-defined rules.

In some embodiments, the method (300) may include, at step 302, creating a grid (e.g., 104) at a cell site (e.g., 102). The method (300) may include, at step 304, receiving a pre-defined grid size input for creating the grid (104). In some embodiments, the cell site (102) may be divided into one or more grids (104) based on the grid size input.

In some embodiments, the method (300) may further include, at step 306, selecting a top north grid. In some embodiments, any grid other than the top north grid may be selected. Further, in some embodiments, the method (300) may include, at step 308, receiving all the samples associated with a data from the selected grid. In some embodiments, the samples may include signal information from one or more user devices (106) from different manufacturers. In some embodiments, the method (300) may further include, at step 310, determining if the received samples are from more than one make and model, for example, the samples may be from two different mobile device manufacturers, or may be different models from the same manufacturer. If the samples are not from two different manufacturers or two different models, the samples may not be evaluated and the method (300) may include, at step 348, ending the process. On the other hand, if the samples are from two different manufacturers or models, the method (300) may include, at step 312, determining if the samples are associated with a same cell ID, for example, all the user devices (106) may belong to the same cell. If the samples are not associated with the same cell ID, the method (300) may include, at step 348, ending the process.

On the other hand, if the samples are associated with the same cell ID, the method (300) may include, at step 314, selecting a first KPI from a list of KPIs for which the user device (106) needs to be evaluated. In some embodiments, the method (300) may include, at step 316, providing a list of KPIs to be evaluated along with respective threshold values. Further, the method (300) may include, at step 318, determining if the KPI value is within a predefined threshold. If the KPI value is less than the predefined threshold, the method (300) may include, at step 322, identifying the make and model of the corresponding user device (106) having the best value and assigning a score value of “1” to the user device (106) for that particular KPI. On the other hand, if the KPI value is more than the predefined threshold, the method (300) may include, at step 320, assigning a score value of “0” to the particular handset or user device (106) for the particular KPI. In some embodiments, all the received samples may be from more than one category of user devices served within the grid by the same cell for that particular KPI. The particular handset or user device (106) is related to one particular/specific make and model. The particular KPI is related to one specific parameter e.g., a reference signal received power (RSRP), a signal to interference and noise ratio (SINR), a channel quality indicator (CQI), a reference signal received quality (RSRQ), call drop, call mute, and uplink (UL) interference, etc. The make and model refers to a company/manufacturer that makes a user device, and the user device's model is the user device's specific name. The method (300) may further include, at step 324, assigning a score value between “0” and “1” for all other user devices (106) in steps (i.e., the user devices other than the user device with score “0” or “1”) based on receiving a score offset input for the particular KPI at step 326. The method (300) may include, at step 328, calculating a grid score based on multiplying the number of samples with the KPI score for all the user devices within the selected grid. The method (300) may further include, at step 330, determining if all the KPIs within the selected grid are evaluated. If all the KPIs within the selected grid are not evaluated, the method (300) may include, at step 332, selecting the next KPI and proceeding with the iterations from step 318.

On the other hand, if all the KPIs within the selected grid are evaluated, the method (300) may include, at step 336, determining if all the grids within a selected cell site (102) or geographical area are evaluated. If all the grids are not evaluated, the method (300) may include, at step 334, selecting a grid that is not evaluated and proceeding with the iterations from step 308.

On the other hand, if all the grids within the selected cell site (102) are evaluated, the method (300) may include, at step 338, calculating each KPI score for each user device as KPI score for user device=((sum grid score *100)/sum of samples). The method (300) may further include, at step 340, calculating a final score associated with the user device as final score =Sum (KPI1 Score*Weight+KPI n) Weight n), based on obtaining, at step 342, weights for calculating a final score for each KPI. The method (300) may further include, at step 344, sorting the user devices (106) based on the final score and marking, at step 346, the user device with the highest score as best performing user device and the user device with the lowest score as poor performance user device. In some embodiments, the weights and thresholds may be preconfigured.

In an example embodiment, for performing the method (300), the disclosed system (e.g., 110) creates a 5×5 meter grid for a given cell site and considers the samples received based on user-measured and reported sample data for pre-defined days (e.g., 15 days). Further, the samples may be considered for scoring if they are associated with user devices with different manufacturers or different models and the user devices are served by the same cell ID, other samples may not be considered for scoring. Further, a particular KPI for comparison may be considered only if samples present for each user device (different make and model) are reported in that grid, else the KPIs may not be considered. In an aspect, the failure KPIs are excluded in this condition. Further, rest of the samples who not fulfilled above conditions will not be consider. An average of all samples of particular make and model is calculated.

In some embodiments, the KPI may include such as, without limitations, at least one of reference signal received power (RSRP), signal to interference and noise ratio (SINR), channel quality indicator (CQI), reference signal received quality (RSRQ), call drop, call mute, and uplink (UL) interference etc. A person of ordinary skill in the art will appreciate that the KPI and parameters are not limited to the ones mentioned in the disclosure but may include any KPI/parameters associated with wireless communication system. Thus, a comparison between the KPIs of different makes and models can be obtained. Further once a particular KPI is available for comparison within grid then scoring of the KPI for each make and model can be performed.

In an example embodiment, the score range for any of the KPIs associated with the user device (106) may include marking the best as 1, worst as 0, and the values in between based on pre-defined steps between 1 and 0. The KPI score may be calculated for all the samples in a grid to obtain a grid score. The grid score may then be multiplied by the weight associated with the KPI to obtain the final score for a particular make and model of the user device (106). The final score provides a ranking of that make and model for a selected geography (geographical region). In some embodiments, the weights and scores may be configurable. In an embodiment, one or more devices may be categorized based on performance. The categorization may be based on the evaluation of the device in the network. Furthermore, the categorization may be based on user-defined scoring criteria.

In an example embodiment, the following scoring steps are followed:

In an aspect, score range for RSRP is revised as:—mark best as 1, anything worse than 10 db as 0 and in between values should define in step of 0.1 from higher to lower i.e. if best is −75 then tag it as 1, −76 as 0.9, −77 as 0.8 etc to −85 as 0.

In an aspect, score range for SINR/CQI/RSRQ is revised as: best as 1, anything 3 db lower as 0 and in between them as 0.7 (near to best) and 0.35 (for remaining value).

In an aspect, for drop and mute consider the exact value. If TA distance is within 300 metre and UE power headroom having value <0, then it may be considered that UE is causing uplink (UL) interference and may count exact such instances for each handset who identified as UL interference source. The power headroom is a mechanism used by User Equipment (UE) to report its available transmit power to the base station (eNodeB) in the LTE network.

In an aspect, the total samples for RSRP/SINR/CQI/RSRQ in grid is obtained. In an aspect, the total samples for drop calls and mute calls i.e., nothing but total calls, the sum of (NE35, NE36, NE22, NE21, NE20, NE6, NE5, NE4, NE3) all these events in grid is considered. Here, NE are the events associated with the drop calls/mute calls. Further, perform multiplication of RSRP/SINR/CQI/RSRQ samples and a score is obtained as per first step for the grid. Sum all samples and sum (multiplication of RSRP/SINR/CQI/RSRQ samples and score) for specific make and model for geography.

In an aspect, similarly, perform sum of drop calls/mute calls and sum of samples of drop calls/mute calls i.e. sum of events (NE35, NE36, NE22, NE21, NE20, NE6, NE5, NE4, NE3) for specific make and model for geography. In an aspect, the final score for RSRP is (SUM (multiplication of RSRP/SINR/CQI/RSRQ samples and score)/SUM (RSRP/SINR/CQI/RSRQ samples))*100.

In an aspect, the final score for drop/mute is 100−(SUM (Drop calls/mute calls)/SUM (samples)*100)

In an aspect, once the final score for a KPI is available, then the final score is multiplied by the corresponding weightage of that KPI to get a ranking of that make and model for selected geography. For example, RSRP weightage is 3.5, CQI/RSRQ/SINR weightage is 2.5, UL interference weightage is 2, call drop weightage is 1.25, and call mute weightage is 0.75. In some aspects, the weightage and score need to be configurable.

A person of ordinary skill in the art will appreciate that these are mere examples and, in no way, limit the scope of the present disclosure.

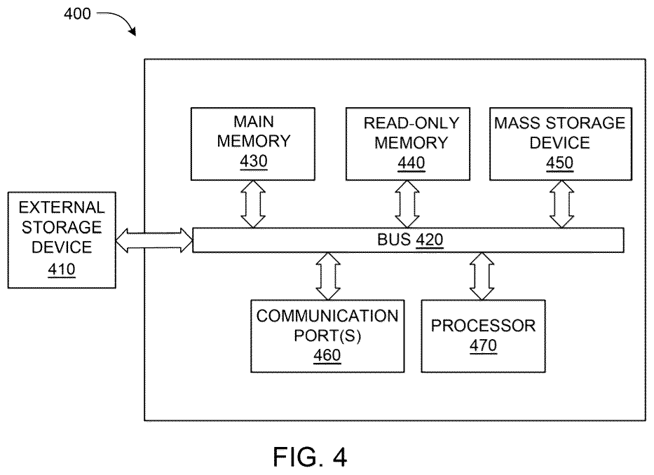

FIG. 4 illustrates an exemplary computer system (400) in which or with which embodiments of the present disclosure may be utilized. As shown in FIG. 4, the computer system (400) may include an external storage device (410), a bus (420), a main memory (430), a read-only memory (440), a mass storage device (450), communication port(s) (460), and a processor (470). A person skilled in the art will appreciate that the computer system (400) may include more than one processor and communication ports. The processor (470) may include various modules associated with embodiments of the present disclosure. The communication port(s) (460) may be any of an RS-232 port for use with a modem-based dialup connection, a 10/100 Ethernet port, a Gigabit or 10 Gigabit port using copper or fibre, a serial port, a parallel port, or other existing or future ports. The communication port(s) (460) may be chosen depending on a network, such a Local Area Network (LAN), Wide Area Network (WAN), or any network to which the computer system (400) connects. The main memory (430) may be random access memory (RAM), or any other dynamic storage device commonly known in the art. The read-only memory (440) may be any static storage device(s) including, but not limited to, a Programmable Read Only Memory (PROM) chips for storing static information e.g., start-up or basic input/output system (BIOS) instructions for the processor (470). The mass storage device (450) may be any current or future mass storage solution, which may be used to store information and/or instructions.

The bus (420) communicatively couples the processor (470) with the other memory, storage, and communication blocks. The bus (420) can be, e.g. a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor (470) to the computer system (400).

Optionally, operator and administrative interfaces, e.g. a display, keyboard, and a cursor control device, may also be coupled to the bus (420) to support direct operator interaction with the computer system (400). Other operator and administrative interfaces may be provided through network connections connected through the communication port(s) (460). In no way should the aforementioned exemplary computer system (400) limit the scope of the present disclosure.

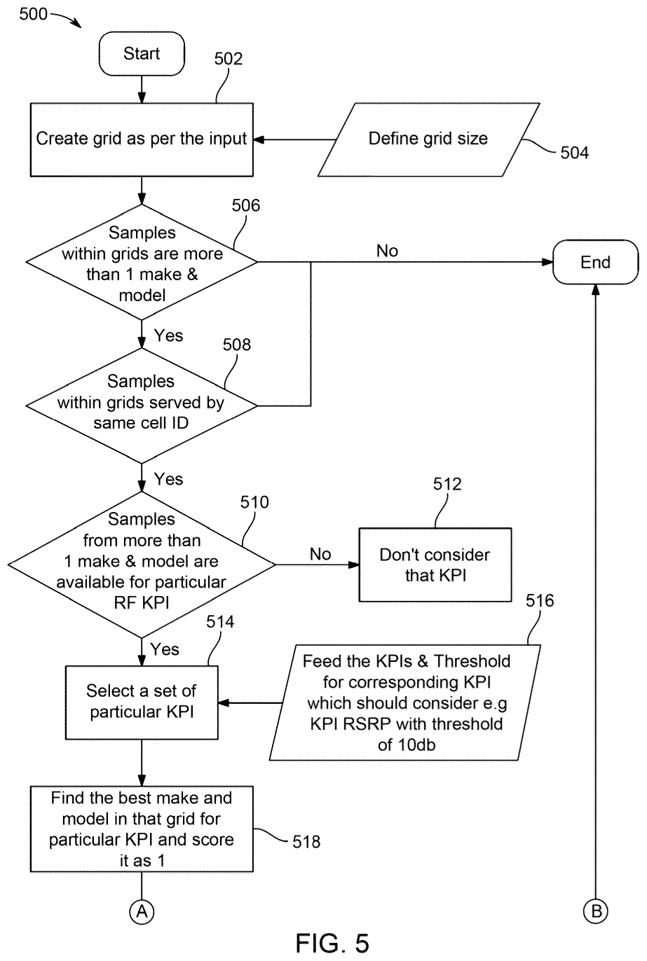

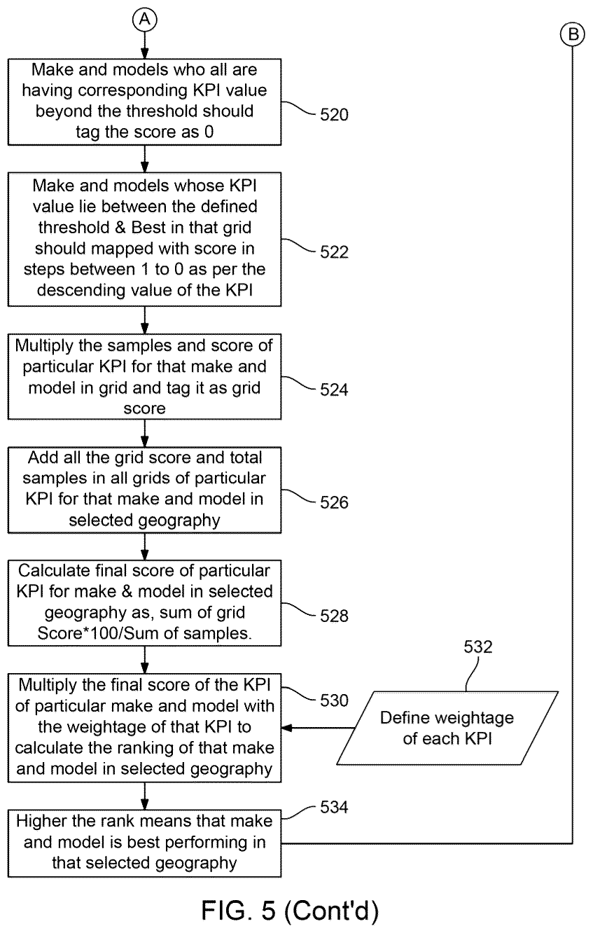

FIG. 5 illustrates an exemplary flow chart for a method (500) for evaluating the performances of devices in the network (108) in accordance with embodiments of the present disclosure.

At step 502, a grid is created as per input grid size defined in step 504.

At step 506, it is checked if the samples within grids are more than 1 make and model. The process ends when step 506 is non-affirmative.

At step 508, when step 506 is affirmative, it is checked if the samples within grids are served by the same cell ID or not. The process ends when step 508 is non affirmative.

At step 510, when the step 508 is affirmative, it is checked if the samples from more than 1 make and model are available for particular Radio Frequency (RF) key performance indicator (KPI).

At step 512, when the step 510 is non-affirmative, that KPI is not considered.

At step 514, when the step 510 is affirmative, a set of particular KPI is selected. The particular KPI is related to one specific parameter e.g., a reference signal received power (RSRP), a signal to interference and noise ratio (SINR), a channel quality indicator (CQI), a reference signal received quality (RSRQ), call drop, call mute, and uplink (UL) interference etc.

At step 516, in order to perform step 514, the KPI are feed and threshold for corresponding KPI which should consider e.g., KPI RSRP with threshold of 10 db is fed.

At step 518, the best user device of a defined make and model in that grid is found for that particular/particular KPI, and it is scored as 1.

At step 520, the make and models who all are having corresponding KPI value beyond the threshold should tag the score as 0.

At step 522, make and models whose KPI value lies between the defined threshold and best in that grid should mapped with score in steps between 1 to 0 as per the descending value of the KPI.

For example, for RSRP:—Identify best make and model in that grid and score it as 1 and anything worse than 10 db as 0 and in between values should define in step of 0.1 from higher to lower, i.e., if best is −75 then tag it as 1, −76 as 0.9, −77 as 0.8 etc to −85 as 0.

For example, for CQI/RSRQ/SINR:—Identify the best make and model amongst all and will score it as 1, anything 3 db lower as 0 and in between them as 0.7 (near to best) and 0.35 (for remaining value).

For example, for Call drop and Call Mute:—Will score −1 for each handset who is having call drop/call mute.

For example, for UL interference:—If timing advance distance is within define distance and the user equipment (UE) power headroom having value <0, then will consider that UE is causing uplink (UL) interference and will score −1.

At step 524, multiply the samples and score of particular KPI for that make and model in grid and tag it as grid score.

At step 526, add all the grid score and total samples in all grids of particular KPI for that make and model in selected geography.

At step 528, calculate final score of particular KPI for make and model in selected geography as, sum of grid score*100/sum of samples.

At step 530, multiply the final score of the KPI of particular make and model with the weightage of that KPI to calculate the ranking of that make and model in selected geography.

At step 532, define weightage of each KPI.

At step 534, higher the rank means that make and model is best performing in that selected geography.

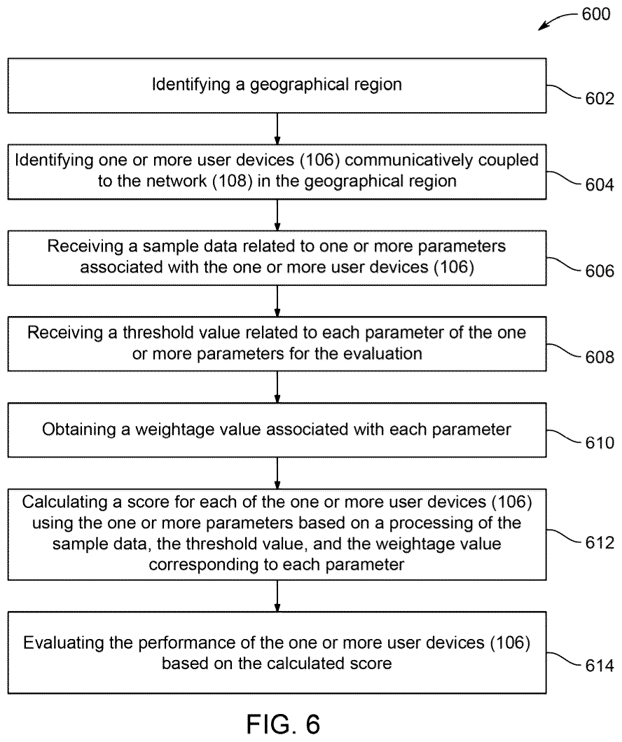

FIG. 6 illustrates another exemplary flow chart for a method for evaluating performances of devices in the network, in accordance with embodiments of the present disclosure.

At 602, the method comprises identifying a geographical region.

At 604, the method comprises identifying one or more user devices communicatively coupled to the network in the geographical region.

At 606, the method comprises receiving a sample data related to one or more parameters associated with the one or more user devices.

At 608, the method comprises receiving a threshold value related to each parameter of the one or more parameters for the evaluation.

At 610, the method comprises obtaining a weightage value associated with each parameter.

At 612, the method comprises calculating a score for each of the one or more user devices using the one or more parameters based on a processing of the sample data, the threshold value, and the weightage value corresponding to each parameter.

At 614, the method comprising evaluating the performance of the one or more user devices based on the calculated score.

In an exemplary embodiment, the present invention discloses a system for evaluating performance of one or more user devices in a network. The system comprises a receiving unit configured to receive sample data related to one or more parameters associated with one or more user devices and receive a threshold value related to each parameter of the one or more parameters for the evaluation. A database configured to store the sample data related to the one or more parameters associated with the one or more user devices and store the threshold value related to each parameter for the evaluation. A processing unit coupled to the receiving unit and the database and is configured to identify a geographical region and identify the one or more user devices communicatively coupled to the network in the geographical region. The processing unit is configured to obtain a weightage value associated with each parameter, calculate a score for each of the one or more user devices using the one or more parameters based on a processing of the sample data, the threshold value, and the weightage value corresponding to each parameter and evaluate the performance of the one or more user devices based on the calculated score.

In an exemplary embodiment, the present invention discloses a user equipment (UE) communicatively coupled with a network in a geographical region. The coupling comprises steps of receiving, by the network, a connection request sending an acknowledgment of the connection request to the UE and transmitting a plurality of signals in response to the connection request. The network comprising a plurality of network elements configured to receive a sample data related to one or more parameters associated with the UE, receive a threshold value related to each parameter of the one or more parameters, obtain a weightage value associated with each parameter, calculate a score for each of the UE using the one or more parameters based on a processing of the sample data, the threshold value, and the weightage value corresponding to each parameter and evaluate performance of the UE based on the calculated score.

Thus, the present invention discloses first identifying the best category of user device amongst all category of user devices in a grid served by a same cell for a particular KPI. Score the best category as 1 for that KPI in that grid. Compare the other category of user devices with it and if any user device is beyond the pre-defined threshold of that KPI then tag the score to that category of user device for that grid as 0. The other category of user devices falling between the pre-defined threshold and the best in that grid are mapped with score in steps between 1 to 0 as per the descending value of the KPI. Similarly, all KPIs in the grid are checked. Thus, the score for each KPI for each category of the user devices reported in that grid and served by same cell are determined. Thus, the individual score of all categories of the user devices that are reported in that grid are derived. Thus, a score for all category of user devices in the network for every grid where they reported is derived. Further, the score of each category of user device for whole geography is derived and all these category of user devices are compared based on its final score. The best to worst user device can be tagged based on the score which is nothing but the radio frequency (RF) performance.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

In an aspect, the present invention relates to system and method for evaluating device performance in network. In an aspect, the present invention facilitates identification of plurality of devices based on the performance, in the network. In an aspect, the present invention enables the service providers to evaluate the active devices in a dynamic manner and henceforth it helps the operators to manage the network in a better and efficient way by optimizing the resources.

In an aspect, the present invention can be implemented in a communication network for analysis of mobile handset experience. In an aspect, the present invention can help the telecom operators to derive best in class network planning and operation strategy. Further, in an aspect, the present invention provides optimization of the network based on analytics, improve productivity, better customer complaints management, and provide best in user experience on various customer touch points not only based on network but for device own by end users. In an aspect, the present invention provides feedback to device manufacture to further improve device performance consider network requirement and increase market share and partnership with multiple operators.

### ADVANTAGES OF THE PRESENT DISCLOSURE

The present disclosure provides a system and a method for mobile handset experience analysis for a communication network.

The present disclosure enables telecom operators and mobile handset manufactures to evaluate handset based on actual user reported measurement data and fine tune network configurations to increase network capacity and utilization with best-in-class user experience.

The present disclosure provides information to study and identify various network related issue for software development, bug fixing, and further enhancement.

The present disclosure provides better management of customer complaints based on user handset make and model by providing faster resolution in case of mobile handset related issues.

The present disclosure provides de-segregation of network related and device related issue for optimizing priority and increase productivity.

The present disclosure provides laboratory vs on field device performance analysis and further implement in future release or devices.

We claim:

1. A method (600) for evaluating performance of one or more user devices (106) in a network (108), the method comprising:
identifying (602) a geographical region;
identifying (604) the one or more user devices (106) communicatively coupled to the network (108) in the geographical region;
receiving (606) a sample data related to one or more parameters associated with the one or more user devices (106);
receiving (608) a threshold value related to each parameter of the one or more parameters;
obtaining (610) a weightage value associated with each parameter;
calculating (612) a score for each of the one or more user devices (106) using the one or more parameters based on a processing of the sample data, the threshold value, and the weightage value corresponding to each parameter; and
evaluating (614) the performance of the one or more user devices (106) based on the calculated score.

2. The method (600) as claimed in claim 1, further comprising dividing the identified geographical area into a grid (104) based on a defined grid size.

3. The method (600) as claimed in claim 2, further comprising selecting a block in the grid (104) having the one or more user devices (106) that are of different makes and models.

4. The method (600) as claimed in claim 3, wherein the one or more user devices (106) are communicatively coupled to the network (108) from a single cell corresponding to the block in the grid.

5. The method (600) as claimed in claim 4, wherein the sample data is associated with the one or more user devices (106) having a same cell identifier (ID) and a same input source.

6. The method (600) as claimed in claim 5, wherein the sample data comprises data related to the one or more parameters measured and reported by the one or more user devices (106) for a pre-defined period of time.

7. The method (600) as claimed in claim 1, further comprising selecting any one parameter for evaluation and calculating an average value of the parameter associated with the one or more user devices of each make and model based on the received sample data.

8. The method (600) as claimed in claim 1, further comprising providing a ranking to each user device of the one or more user devices of different makes and models in the identified geographical area based on the calculated score.

9. The method (600) as claimed in claim 1, wherein the one or more parameters include at least one of a reference signal received power (RSRP), a signal-to-interference-plus-noise ratio (SINR), a channel quality information (CQI), a reference signal received quality (RSRQ), call drop, call mute and an uplink (UL) interference.

10. A system (110) for evaluating performance of one or more user devices (106) in a network (108), the system comprising:
a receiving unit (212) configured to:
receive a sample data related to one or more parameters associated with the one or more user devices (106); and
receive a threshold value related to each parameter of the one or more parameters;
a database (210) configured to:
store the sample data related to the one or more parameters associated with the one or more user devices (106); and
store the threshold value related to each parameter for evaluation; and
a processing unit (208) coupled to the receiving unit (212) and the database (210) and is configured to:
identify a geographical region;
identify the one or more user devices (106) communicatively coupled to the network (108) in the geographical region;
obtain a weightage value associated with each parameter;
calculate a score for each of the one or more user devices (106) using the one or more parameters based on a processing of the sample data, the threshold value, and the weightage value corresponding to each parameter; and
evaluate the performance of the one or more user devices (106) based on the calculated score.

11. The system (110) as claimed in claim 10, further configured to divide the identified geographical area into a grid (104) based on a defined grid size.

12. The system (110) as claimed in claim 11, further configured to select a block in the grid (104) having the one or more user devices (106) that are of different makes and models.

13. The system (110) as claimed in claim 12, wherein the one or more user devices (106) are communicatively coupled to the network (108) from a single cell corresponding to the block in the grid of the same geographical area.

14. The system (110) as claimed in claim 13, wherein the sample data is associated with the one or more user devices (106) having a same cell identifier (ID) and a same input source.

15. The system (110) as claimed in claim 14, wherein the sample data comprises data related to the one or more parameters measured and reported by the one or more user devices (106) for a pre-defined period of time.

16. The system (110) as claimed in claim 10, further configured to select any one parameter for evaluation and calculate an average value of the one parameter associated with the for each device of the one or more devices of different make and model based on the received sample data.

17. The system (110) as claimed in claim 10, further configured to provide a ranking to each user device of the one or more user devices having different makes and models in the identified geographical area based on the calculated score.

18. The system (110) as claimed in claim 10, wherein the one or more parameters include at least one of a reference signal received power (RSRP), a signal-to-interference-plus-noise ratio (SINR), a channel quality information (CQI) and a reference signal received quality (RSRQ), call drop, call mute and an uplink (UL) interference.

19. A user equipment (UE) (106) communicatively coupled with a network (108) in a geographical region, the coupling comprises steps of:
receiving, by the network (108), a connection request;
sending an acknowledgment of the connection request to the UE (106); and
transmitting a plurality of signals in response to the connection request, wherein the network comprising a plurality of network elements configured for:
receiving a sample data related to one or more parameters associated with the UE (106);
receiving a threshold value related to each parameter of the one or more parameters;
obtaining a weightage value associated with each parameter;
calculating a score for each of the UE (106) using the one or more parameters based on a processing of the sample data, the threshold value, and the weightage value corresponding to each parameter and evaluate performance of the UE (106) based on the calculated score.

20. A computer program product comprising a non-transitory computer-readable medium comprising instructions that, when executed by one or more processors, cause the one or more processors to perform a method for evaluating performance of one or more user devices (106) in a network (108), the method comprising:
identifying a geographical region;
identifying one or more user devices (106) communicatively coupled to the network (108) in the geographical region;
receiving a sample data related to one or more parameters associated with the one or more user devices (106);
receiving a threshold value related to each parameter of the one or more parameters for evaluation;
obtaining a weightage value associated with each parameter;
calculating a score for each of the one or more user devices (106) using the one or more parameters based on a processing of the sample data, the threshold value, and the weightage value corresponding to each parameter; and
evaluating performance of the one or more user devices (106) based on the calculated score.
